(19) United States
(12) Patent Application Publication
(10) Pub. No.: US 2006/0270400 A1
(43) Pub. Date: Nov. 30, 2006

(54) Methods and structures for improved monitoring and troubleshooting in wireless communication systems

(75) Inventors: Victor M. DaSilva, Succasunna, NJ (US); Vijayanand K. Paulrajan, Bridgewater, NJ (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/141,225

(22) Filed: May 31, 2005

(51) Int. Cl. H04Q 7/20

(52) U.S. Cl. 455/423; 455/67.11

(57) ABSTRACT

Methods and systems for correlating a variety of sources monitored or test data gather from a wireless communication system to provide a more complete view of performance of, and problems arising in a wireless communication system. Features and aspects hereof combine and correlate gathered RF information associated with the wireless system with gathered network information associated with the network aspects of the wireless communication system. The gathered information may be correlated in time, and/or location, and/or other aspects. So correlating a variety of information sources including both RF information and network information provides a more complete view of performance and problems associated with a wireless communication system thus improving the ability of service providers and equipment providers to rapidly troubleshoot and isolate problems in a wireless communication system.

### BACKGROUND OF THE INVENTION

1. Field of the Invention

The invention relates generally to monitoring and troubleshooting and performance monitoring of wireless communication systems and in particular relates to methods and systems for correlating a variety of sources of monitored information to provide a more complete picture for troubleshooting cellular telephony and other wireless networks.

2. Statement of the Problem

Cellular or wireless telephony communication systems combine features of radio frequency (“RF”) communication devices and networking systems. In general, multiple cellular telephones or other wireless communication devices communicate with a base station utilizing radio frequency, digital communication techniques. The base station may then communicate with other networking features using networking protocols and communication media. The network or networking features, as used herein, may include, for example, voice networks (such as traditional switched circuit voice networks), data networks (such as packet data networks), and combinations of voice and data networks (such as packet networks where both voice and data are exchanged as digitized packets).

Providers of cellular or wireless telephony equipment and services frequently need to analyze and/or monitor a number of aspects of the entire telephony system to improve quality and troubleshoot problems that may arise. To this end, a number of vendors provide test and monitoring equipment often referred to as autonomous probes configured to monitor and test the radio frequency features and capabilities for communication between radio frequency wireless devices and one or more base stations in a geographic area. These autonomous probes generally comprise a plurality of modified wireless communication devices enclosed within a test enclosure and transported throughout a geographic area covered by one or more base stations. As the traveling autonomous probes are transported, the plurality of modified wireless communication devices tests the RF communication capabilities and simultaneously monitors the present location of the device utilizing well-known GPS techniques. The autonomous probe devices then communicate the acquired, accumulated test data back to an analysis system for further processing and analysis by service engineers associated with the wireless communication system.

Such autonomous probe capabilities generally monitor only the RF aspects of the wireless communication system. However, these autonomous probe devices have no information relating to network aspects of the cellular or wireless telephony communication system. A problem detected at the RF monitoring (e.g., such as a dropped telephone call) could be a problem that, though detected by the RF monitoring of the probe, does not arise from the RF features and aspects of the wireless communication system.

In like manner, a number of standard network monitoring and test devices are well known in the industry to monitor the networking aspects of a cellular or wireless telephony communication system. Such network monitoring devices and systems monitor data exchanged through the telephony network to detect, for example, capacity constraints within the network, dropped calls due to network congestion, hardware failures within the telephony network, power overload conditions, etc. However, such network monitoring and test devices do not provide sufficiently granular data to determine an exact geographic location for a particular failure, such as a dropped call with a corresponding wireless or cellular device. Rather, the monitored network data may identify that the problem occurred and may identify a wireless device that was involved with the dropped call but the precise location of the device at the time of the incident is not generally known to the test systems. Thus, problems identified by the network monitoring and test devices and systems cannot easily determine if a problem is associated with RF aspects of a particular geography. In other words, a large number of dropped calls may be associated with a particular geographic area but such information is not generally available to the network monitoring devices and systems.

It is evident from the above discussion that an ongoing problem exists for equipment and service providers in the wireless or cellular telephony communication industry to adequately monitor and evaluate all aspects of the system to generate a complete picture of performance in a wireless communication system. To locate and correlate enough diverse sources of test data to generate such a complete view is an impossible manual task. No automated methods or processes presently exist to acquire monitored information from a variety of test devices to present a complete view of performance aspects of a wireless communication system.

### SUMMARY OF THE SOLUTION

The present invention solves the above and other problems, thereby advancing the state of the useful arts, by providing methods and systems for correlating multiple sources of testing and monitoring data associated with a wireless communication system. More specifically, features and aspects hereof provide for correlation of monitored information pertaining to the radio frequency transmission aspects of a wireless communication system as well as the network aspects of a wireless communication system. By so correlating a variety of sources of monitored information, features and aspects hereof provide a more complete view of performance and problems in a wireless communication system. Still more specifically, features and aspects hereof correlate information derived from autonomous probes along with a variety of other RF test sources and monitored information associated with the network aspects of the wireless communication system. Such correlation provides a more complete view of the entire wireless communication system to enhance capability of an equipment or service provider to isolate and resolve problems in the entire network system and to monitor and improve performance aspects of the system.

In one aspect hereof, a wireless communication test system is provided. The test system includes a wireless monitoring device for gathering information regarding RF aspects of a wireless communication system. The test system also includes a network data monitoring device for gathering information regarding network aspects of the wireless communication system. Lastly, the test system may also include a system performance analysis tool adapted to correlate information gathered by the wireless monitoring device and by the network monitoring device.

In another aspect hereof, a method is provided for monitoring a wireless communication system. The method includes gathering RF information from an RF monitoring device wherein the RF information includes link information regarding an RF link between a wireless device and a base station. The method also includes gathering network information from a network monitoring device. The method then includes automatically correlating the network information with the RF information, and reporting a problem in the wireless communication system based on the correlated information.

The structures and methods may also include a rules evaluation engine to identify problems in the correlated data. The rules may be applied to the correlated information by the rules engine to identify problems in the communication system based on the correlated information. For example, a number of reasons for dropped calls may be identified by rules applied to the correlated information.

The invention may include other exemplary embodiments described below.

### DESCRIPTION OF THE DRAWINGS

The same reference number represents the same element on all drawings.

FIG. 1 is a block diagram of a wireless communication system coupled to a wireless communication test system enhanced in accordance with features and aspects hereof.

FIG. 2 is a block diagram providing additional details of an exemplary wireless communication test system in accordance with features and aspects hereof.

FIG. 3 is a flowchart describing a method in accordance with features and aspects hereof to correlate multiple source of information about a wireless communication system to identify problems and potential solutions.

FIG. 4 is a flowchart providing additional details of an exemplary correlation process to correlate multiple source of information regarding a wireless communication system in accordance with features and aspects hereof.

### DETAILED DESCRIPTION OF THE INVENTION

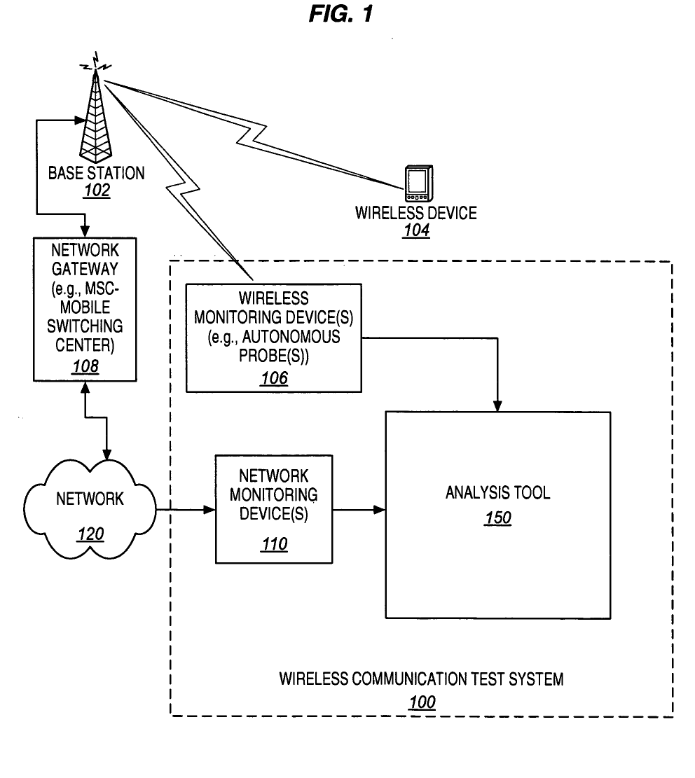

FIGS. 1-4 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 shows a wireless communication test system 100 adapted for correlating and analyzing multiple sources of test data associated with a wireless communication system. A typical wireless communication system includes one or more base stations 102 adapted to enable communication with multiple wireless devices 104 utilizing radio frequency (“RF”) communication encoding and modulation techniques. In the context of cellular telephony wireless communication systems, base station 102 is coupled to mobile switching center (“MSC”) 108 using standard network communication protocols. The MSC acts, in essence, as a gateway for directing data through network 120. Through the MSC 108, multiple base stations 102 may exchange information to thereby enable the exchange of information between wireless devices 104 geographically separated from one another or to enable wireless devices to exchange information with land based wired communication networks (including, for example, standard telephony networks as well as computer data networks).

Wireless communication test system 100 includes one or more wireless monitoring devices 106 and one or more network data monitoring devices 110. Wireless monitoring devices 106 (also commonly known as “autonomous probes” in the context of cellular telephony wireless communication systems) are devices known in the art to enable monitoring of wireless communication exchanges with base station 102. Autonomous probes, for example, are generally known in the art and often include the equivalent of multiple wireless devices such as cellular phones integrated within a customized test box. The autonomous probe test box with multiple wireless devices is then transported around the proximity of one or more base stations 102. Each of the multiple wireless devices in the autonomous probe continuously tests communication with a base station to evaluate the quality and performance of RF communication with each base station. The wireless devices may be standard wireless devices such as cellular telephones adapted with custom programmed instructions to gather test data and forward the test data to the test box for archival storage or simply may retain the test data until downloaded for analysis. Regardless of the particular architecture, all presently known autonomous probes gather data only relating to RF aspects of the communication system.

Network data monitoring devices 110 may be any of several commercially available devices for monitoring exchanges on a communication network. Such devices are often referred to as network monitors, network analyzers, sniffers, etc. A number of such devices are specifically adapted for monitoring data in a cellular telephony network on a per call basis. Such data is often referred to as Per Call Measurement Data (“PCMD”) and may include information relating to a particular cellular telephony exchange as call information moves through the network. Other well-known network data monitoring devices may provide information regarding the entire network as a whole including, for example, performance information indicative of network congestion as well as error and status information indicative of the quality of information exchanged on the network.

As presently known in the art, autonomous probe data (“RF information”) represents information, in isolation, regarding operation and status of RF aspects of a wireless communication network. Such autonomous probes provide no useful information regarding the network aspects of the wireless communication system. Conversely, network monitoring devices may provide status or performance information regarding the network aspect of the wireless communication system but provide no useful information regarding the RF aspects of the wireless communication system. Although certain problems regarding a wireless communication system may be identified and resolved solely with reference to the RF information or solely with reference to the network information, a large class of problems may be resolved efficiently only by understanding a more complete view of the operation and performance of the entire wireless communication system including both the wireless network aspects and the network aspects. Thus, proper analysis for resolving all problems requires significant correlation of the otherwise disjoint, acquired data from multiple sources.

In accordance with features and aspects hereof, analysis tool 150 of wireless communication test system 100 receives the RF information gathered by the wireless monitoring devices 106 and the network information gathered by the network data monitoring devices 110 and automatically correlates the information to provide a more complete view of the performance, the operation, and the status of the entire wireless communication system. In general, as discussed in further detail herein below, analysis tool 150 may include systems and methods for correlating the information gathered from such a plurality of monitoring sources, including both wireless monitoring devices 106 and network data monitoring devices 110. Such information may be correlated in accordance with any number of parameters including, for example, time correlation, telephone number correlation (e.g., in the context of a telephony network), location information as may be gathered through GPS techniques, and other correlating factors associating the wireless communication information gathered by devices 106 and network information gathered by devices 110.

In addition, analysis tool 150 may include methods and associated systems for analyzing the data so correlated to identify problems, likely causes thereof, and resolutions for such problems. In one exemplary embodiment, analysis tool 150 may include a rules-based analysis engine to evaluate rules applied to the correlated data for identifying likely problems in the wireless communication system. In addition to identifying one or more problems, the rules-based engine may also identify likely causes and solutions to the identified problems. A report or display may then be generated by the analysis tool to inform a user of likely identified problems and possible solutions associated therewith.

The rules to be evaluated by the analysis tool rules-based engine may be statically defined for identifying particular common problems or may be dynamically defined by appropriate personnel to permit ad hoc identification of problems.

Those of ordinary skill in the art will recognize that FIG. 1 is intended merely as representative of one exemplary wireless communication system coupled to an exemplary wireless communication test system 100 enhanced in accordance with features and aspects hereof. In particular, those of ordinary skill in the art will recognize that wireless device 104 may represent any wireless communication device adapted for communication with one or more base stations 102. For example, cellular telephones, personal digital assistants, laptop computers, etc. all may be examples of wireless devices 104 capable of exchanging information through wireless RF communication with one or more base stations 102. Still further, base stations 102 may be coupled through any of several well-known communication techniques to appropriate networks 120. MSC 108 is therefore intended merely as exemplary of one common interface for such coupling of a base station 102 to a network 120 where the wireless communication system is a cellular telephony communication system. Other forms of wireless communication systems may utilize other devices as gateways, routers, switches or the like to couple the base station 102 to the network 120.

Still further, those of ordinary skill in the art will recognize that any number of wireless monitoring devices 106 may be associated with wireless communication test system 100 and adapted for monitoring various RF aspects of wireless communication subsystems. Similarly, any number of network data monitoring devices 110 may be associated with wireless communication test system 100 to monitor for a variety of network conditions and status.

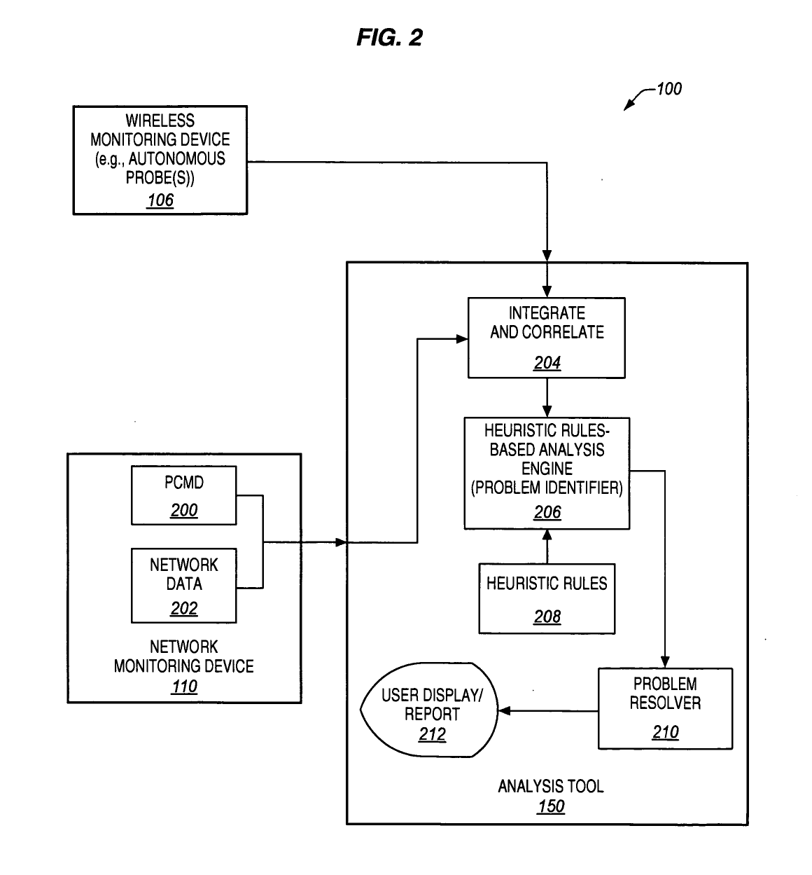

FIG. 2 provides additional details of functional elements within an exemplary analysis tool 150 in accordance with features and aspects hereof. As noted above with respect to FIG. 1, wireless communication test system 100 may include analysis tool 150 for gathering RF information regarding RF aspects of the wireless communication system and for gathering network information regarding the network aspects of the wireless communication system. Analysis tool 150 receives monitored information from a variety of sources including, for example, the wireless monitoring devices 106 and network data monitoring devices 110. Included among the sources are typically at least one source for monitoring the RF aspects of a wireless communication system under test and at least one monitoring device for monitoring network aspects of a wireless communication system.

An autonomous probe (e.g., 106) gathers information regarding the RF operation of one or more base stations and typically, simultaneously gathers location information derived from GPS signals processed by the autonomous probe. The RF information so acquired is then forwarded to the analysis tool 150 for further processing. Network data monitoring device 110 may comprise one or more PCMD monitor devices 200 for acquiring per call network information as well as one or more network data monitoring devices 202 for gathering information pertaining to the entire network rather than a particular call exchanged over the network. Such network information acquired by network data monitoring device 110 is also forwarded to analysis tool 150 for further processing.

Analysis tool 150 may comprise a number of functional elements that cooperate to gather and correlate the acquired information and to analyze the correlated information to identify problems in the wireless communication system. Analysis tool 150 may include a functional element 204 to correlate information acquired by devices 106 and 110. As noted above, such correlation may utilize common information elements associated with both the received RF information and the received network information. For example, such common information may include: timing information, telephone number or other identification indicia, location information, network segment information, etc. Using one or more of such common data elements, functional element 204 may correlate the information into a canonical form such that a more complete view of the operation, the performance, and the status of the entire wireless communication system may be analyzed.

The monitored data so gathered and correlated by operation of element 204 may then be further analyzed by rules-based engine 206. Rules-based engine 206 receives the correlated information from element 204 and applies rules to analyze the correlated data for purposes of identifying any potential problems in the wireless communication system associated with the acquired data. The heuristic rules 208 may comprise any suitable definition of a test to be performed by the rules-based engine 206 to identify one or more such problems in the associated wireless communication system. The rules-based engine 206 parses and processes the supplied rules by applying the rules to the correlated acquired data to identify one or more problems in the wireless communication system.

One exemplary problem that may be more easily identified utilizing features and aspects hereof is that of dropped calls in a cellular telephony wireless communication system. The root cause of a group of related dropped calls may reside in the network or in the RF aspects of the wireless communication system. Exemplary rules as discussed further herein below may more easily identify the root cause of such dropped calls by analyzing the correlated information.

When rules-based engine 206 identifies a problem in the underlying wireless communication system under test, the identified problem may also be forwarded to problem resolver 210 to determine possible solutions to the identified problem. Possible solutions may be extracted from a database or any other suitable storage structures and may be indexed by the identified problem. Potential solutions for the identified problem may then be presented to a user through a user display or report 212. Exemplary reporting information identifying possible solutions to identified problems is discussed further herein below.

As noted above, heuristic rules 208 may represent any suitable rules for identifying one or more types of problems in the underlying wireless communication system under test. The rules 208 may be applied to the acquired, correlated data. Heuristic rules 208 may be statically defined as a set of fixed rules for identifying a fixed set of problems in an underlying wireless communication system.

In addition, heuristic rules 208 may include methods and apparatus for allowing dynamic definition of rules to be applied to the acquired, correlated information. Such ad hoc inquiries may be defined, for example, using boolean query languages such as are generally known in the art. Any suitable query language may therefore be utilized to define a dynamic set of heuristic rules 208 to be applied to the acquired, correlated data.

As noted above, rules may be applied to the correlated information to identify potential problems in the communication system based on the correlated data and to identify possible solutions to those identified problems. For example, where a cellular communication system is experiencing a significant number of dropped calls, it is difficult to identify the possible root cause from only the wireless system information captured by an autonomous probe or from only the information relating to the network. Exemplary rules for determining the root cause of dropped calls may include, for example, the following:

1. Missing neighbor rule: Correlate dropped call information from RF information gathered by an autonomous probe for particular network segments and compare against neighbor lists from configuration data for those network segments. If the RF signal from one of the network segments is strong but is not involved in the call and if that network segment is missing from the neighbor lists, then the analysis result of this rule is a missing neighbor.

2. Non-optimal parameter rule: Correlate dropped call information from an autonomous probe for particular network segments and verify if the configuration parameter setting (e.g., search window sizes) for those network segments are optimal.

3. Handoff blocking rule: Correlate dropped call information from an autonomous probe for particular network segments and compare against network handoff blocking statistics for the network segments in the call as well as the network segments in the vicinity.

In addition to the above exemplary rules that help identify possible causes for dropped calls in a cellular communication system, other exemplary rules will be apparent to those of ordinary skill in the art to help determine optimal threshold parameters and neighbor lists for inter-frequency handoffs.

Examples of RF information may include: signal strengths from autonomous probes, call status information, and handoff status information. Examples of network information may include: service/performance measurements, fault management, configuration management, PCMD, switch traffic data, handoff statistics, and base station locations. Common elements of data that may be provided both by sources monitoring the RF network (i.e., autonomous probes) and by sources monitoring the network may include: timing information, phone number (i.e., in a cellular communication system), network segments involved in a call, and call location information (i.e., GPS or other location information). These latter common elements of data may be used to correlate the other elements of RF information and network information. The information so correlated may then be used in conjunction with the rules engine to identify likely root causes of problems in the communication system.

In addition to identifying possible root causes of possible problems, features and aspects hereof may report possible solutions to the identified problems. For example, a report such as that below may report identified problems, possible causes (reasons) and potential solutions.

| | Cell | Sector | Carrier | Drop Call | Drop Call | |
|---|---|---|---|---|---|---|
| System | Number | Number | Number | Timestamp | Failure Reason | Potential Solution |
| 5 | 1 | 1 | 7 | May 27, 2005 | Lost Call Before | Missing Neighbor: Non- |
| | | | | 2:16:36 PM | Answer | active sector 5_2_1 |
| | | | | | | (Ec/lo: −12 dB) not found |
| | | | | | | in any of the A-set |
| | | | | | | sector's NL |
| 5 | 1 | 2 | 5 | May 27, 2005 | Lost Call After | Weak Active Set pilots: |
| | | | | 2:02:58 PM | Answer | Ec/lo < −15 dB |
| 5 | 1 | 3 | 4 | May 27, 2005 | Cell Shutdown | Missing Neighbor: Non- |
| | | | | 2:11:43 PM | Handoff | active sector 5_2_1 |
| | | | | | Complete | (Ec/lo: −9.5 dB) not found |
| | | | | | Timeout | in any of the A-set |
| | | | | | | sector's NL |
| 5 | 1 | 3 | 7 | May 27, 2005 | Lost Call After | Weak Active Set pilots: |
| | | | | 2:25:41 PM | Answer | Ec/lo < −15 dB |
| 5 | 2 | 2 | 7 | May 27, 2005 | Cell Shutdown | Missing Neighbor: Non- |
| | | | | 2:17:46 PM | Handoff | active sector 5_117_2 |
| | | | | | Complete | (Ec/lo: −12 dB) not found |
| | | | | | Timeout | in any of the A-set |
| | | | | | | sector's NL |
| 5 | 3 | 1 | 1 | May 27, 2005 | Lost Call After | Weak Active Set pilots: |
| | | | | 2:20:27 PM | Answer | Ec/lo < −15 dB |
| 5 | 3 | 1 | 2 | May 27, 2005 | Cell Shutdown | Warning: Non-optimal A- |
| | | | | 2:17:16 PM | Handoff | set 5_296_2 srch window |
| | | | | | Complete | size of 7 (delay of 31 |
| | | | | | Timeout | chips). Consider |
| | | | | | | increasing to 8 |
| | | | | | | Weak Active Set pilots: |
| | | | | | | Ec/lo < −15 dB |
| 5 | 3 | 2 | 7 | May 27, 2005 | Cell Shutdown | Warning: Non-optimal A- |
| | | | | 2:16:09 PM | Handoff | set 5_160_2 srch window |
| | | | | | Complete | size of 7 (delay of 19 |
| | | | | | Timeout | chips). Consider |
| | | | | | | increasing to 8. |
| | | | | | | RECIPROCITY: 5_3_2 |
| | | | | | | does not have 5_160_2 in |
| | | | | | | its NL |

Those of ordinary skill in the art will recognize a variety of equivalent functional elements that may reside within analysis tool 150. Further, those of ordinary skill in the art will recognize that analysis tool 150 represents functional elements that may operate on any suitable computing system capable of gathering monitored data, correlating the monitored data acquired from both wireless sources and network sources, analyzing the correlated data to identify problems, analyzing the correlated data utilizing heuristic rules, identifying potential solutions related to identified problems, etc. For example, analysis tool 150 may be embodied in a standard personal computer or workstation adapted for receiving and gathering monitored information from a variety of data acquisition sources.

Still further, the rules may be defined using any of several well known syntax and formats. For example, simple boolean logic predicates may define tests to be applied to the correlated data. Further, as is well known in the art, well known database management query languages may provide a useful framework for defining the join operations to correlate the various sources of information and to report the likely causes and possible solutions for each problem. Numerous other formats and semantics will be readily apparent to those of ordinary skill in the art for embodying the rules and the rules evaluation engine.

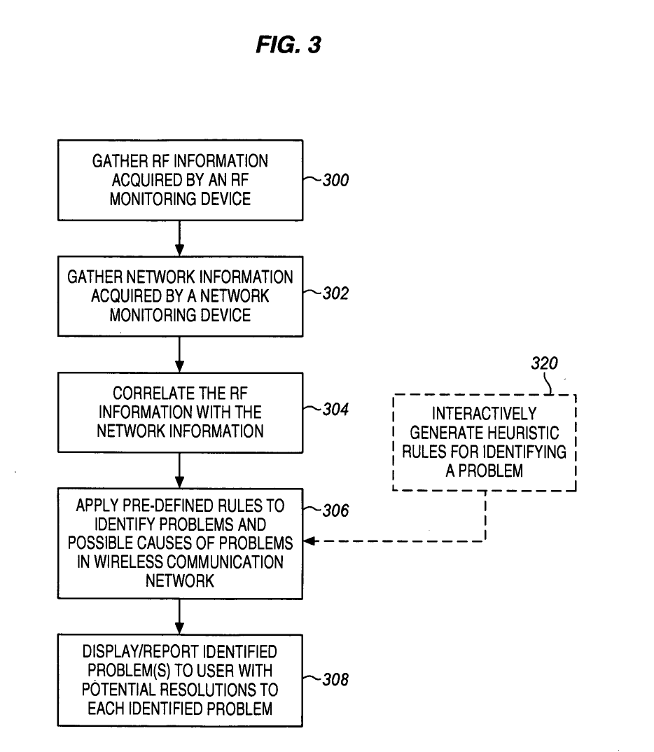

FIG. 3 is a flowchart representing a method associated with features and aspects hereof to gather monitored information from a variety of sources associated with a wireless communication system and to correlate and analyze the data received from such multiple sources. The exemplary method of FIG. 3 may be operable within the exemplary analysis tool of FIGS. 1 and 2 and therefore may be performed by any suitably programmed system adapted for performing the functions of the analysis tool discussed above.

Element 300 is operable to gather RF information from the wireless monitoring devices. As noted above, in the exemplary application to a cellular telephony wireless communication system, element 300 may be operable to gather data acquired by the devices in an autonomous probe. Such gathering from an autonomous probe or other similar wireless communication devices may be performed in real time via direct communication with the probe device or may be achieved as a batch process following completion of the data acquisition by the wireless monitoring device. In like manner, element 302 gathers network information acquired by a network monitoring devices. As above with respect to element 300, the gathering of step 302 may be performed in real time by direct network communication between the analysis tool and the network monitoring device or may be performed as a batch process following completion of the data acquisition process of the monitoring device. Such design choices will be readily apparent to those of ordinary skill in the art.

The analysis tool next correlates the gathered RF information with the gathered network information by operation of element 304. As noted herein above, the correlation may be performed with respect to any of several common data elements or fields in the gathered RF information and the gathered network information. For example, such common data elements may include: timing information, location information, telephone number or other identification information, network segment information, etc. The following table represents exemplary RF information, exemplary network information, and common data elements that typically exist in both the RF and network information. The common data elements may be used to correlate the RF and network information such as by use of database join techniques and structures.

| | | Common |
|---|---|---|
| RF information | Network information | data elements |
| Signal strengths from | Service/Performance | Timing |
| autonomous probe data | measurements | |
| Call status | Fault Management | Phone number |
| Handoff status | Configuration Management | Network segments |
| | | involved in call |
| | Per Call Measurement Data | Call location |
| | (PCMD) | information (GPS) |
| | Switch traffic data | |
| | Handoff statistics | |
| | Base station locations | |

Those of ordinary skill in the art will readily recognize a variety of data structures and data management techniques that may be utilized to represent the correlated data. For example, the RF information may be represented as a first database table and the network information may be represented as a second database table. The correlated information may then be represented as a third database table representing a join of the first two database tables using a common data element to perform the requested join. Such database management structures and techniques as well as other similar data management techniques for performing the desired correlation will be readily apparent to those of ordinary skill in the art.

Element 306 then represents operation of a rules-based engine to analyze the gathered, correlated information. Element 306 applies a predefined set of rules useful to identify one or more problems in operation of the underlying wireless communication system under test. The rules are applied to the correlated information to identify potential problems as well as likely causes of any identified problems. The rules may be specified and encoded in any suitable syntax or language useful for such rule expression including, for example, well known languages for defining boolean predicate logic tests. For example, simple boolean logic and tagged data field definitions may be used to define simple rules to be applied to the acquired, correlated data.

Element 320 represents an optional feature noted as above for dynamically generating heuristic rules in conjunction. Element 320 may interact with an appropriate user or operator to receive newly defined rules to be applied to the correlated data. User interaction apparatus and methods to generate new rules will be readily apparent to those of ordinary skill and the art. Such dynamically defined rules may comprise a portion of, or the entirety of the predefined rules applied by element 306 to the correlated data.

Following application of any appropriately predefined heuristic rules to the correlated data by operation of element 306, element 308 is then operable to display or otherwise report to a user any identified problems along with potential solutions for each identified problem. Potential solutions for an identified problem may be extracted from a database or other data storage indexed by the identified problems. Such an exemplary display or report identifies any potential solutions to each identified problem. An example of such a report is provided herein above.

Those of ordinary skill in the art will readily recognize a variety of equivalent method steps and procedures for performing the correlation of gathered information and analysis thereof to provide a more complete view of operation and status of an underlying wireless communication system. Rules-based analysis of the gathered, correlated information therefore allows improved identification of potential problems in operation of the wireless communication system and identification of associated solutions for the identified problems.

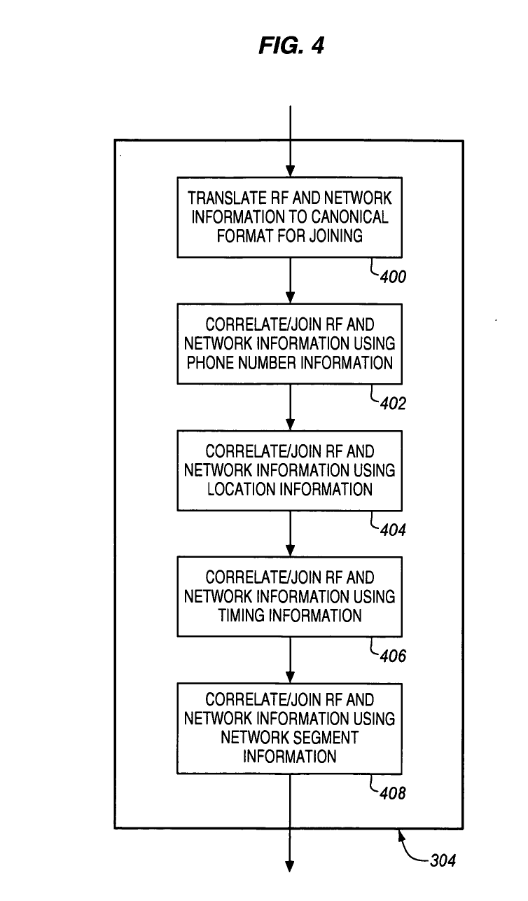

FIG. 4 represents additional details of an exemplary implementation of element 304 in FIG. 3 to correlate the gathered RF information and network information to permit improved analysis. Element 400 of FIG. 4 is first operable to translate the RF information and network information gathered from multiple sources into a canonical format ready for joining in a database table. As noted above, well-known database management techniques may be used for representing the gathered RF information and the gathered network information. A defined canonical or a normalized form may then be used for joining the various independent sources of gathered information. Element 402 then performs database management steps to correlate or join the RF information and the network information using, for example, phone number information. Element 404 similarly correlates or joins the RF information and network information using location information. Elements 406 and 408 similarly correlate or join the RF information and network information using timing fields and network segment fields, respectively. Those of ordinary skill in the art will readily recognize that any number of common data elements may be used for correlation or joining purposes. Elements 402 through 408 are therefore merely intended as representative of exemplary data fields that may be used for correlating or joining the RF information and the network information gathered from multiple sources.

We claim:

1. A wireless communication test system comprising:
a wireless monitoring device for gathering information regarding RF aspects of a wireless communication system;
a network data monitoring device for gathering information regarding network aspects of the wireless communication system; and
a system performance analysis tool coupled to the wireless monitoring device and coupled to the network data monitoring device and adapted to correlate information gathered by the wireless monitoring device and by the network monitoring device.

2. The system of claim 1 wherein the wireless monitoring device includes:
an autonomous probe for gathering RF information regarding RF aspects of the wireless communication system and for gathering location information regarding location of the autonomous probe correlated to the RF information.

3. The system of claim 1 wherein the network data monitoring device includes:
a per call mobile data gathering device for gathering network information regarding network exchanges relating to a particular call.

4. The system of claim 1 wherein the network data monitoring device includes:
a network data gathering device for gathering network information regarding performance and/or status of the network.

5. The system of claim 1 wherein the system performance analysis tool further comprises:
a rules-based analysis engine to identify problems in the wireless communication systems by applying rules to the correlated information.

6. The system of claim 5 wherein the rules-based analysis engine is operable to apply a rule to identify a root cause for dropped calls in a cellular telephony system.

7. The system of claim 6 wherein the rules-based analysis engine is operable to apply a rule selected from the group consisting of: missing neighbor rule; non-optimal parameter rule; and handoff blocking rule.

8. A method for monitoring a wireless communication system comprising:
gathering RF information from an RF monitoring device wherein the RF information includes link information regarding an RF link between a wireless device and a base station;
gathering network information from a network monitoring device;
automatically correlating the network information with the RF information; and
reporting a problem in the wireless communication system based on the correlated information.

9. The method of claim 8 wherein the step of gathering RF information further comprises:
gathering RF information from an autonomous probe.

10. The method of claim 8 wherein the step of correlating includes:
correlating the RF information and the network information based on timing information associated with the RF information and with the network information.

11. The method of claim 8 wherein the step of correlating includes:
correlating the RF information and the network information based on location information associated with the RF information and with the network information.

12. The method of claim 11 wherein the step of correlating by location includes:
correlating by location using network sector information in the network information and using GPS location information in the RF information.

13. The method of claim 8 wherein the step of reporting a problem includes:
reporting a reason for a plurality of related dropped calls as due to one or more RF problems or as due to one or more network problems.

14. The method of claim 8 further comprising:
applying the correlated information to rules-based engine to identify the problem by evaluating heuristic rules applied to the correlated information.

15. The method of claim 14 wherein the step of applying further comprises applying a rule to identify a root cause for dropped calls in a cellular telephony system.

16. The method of claim 15 wherein the step of applying further comprises applying a rule selected from the group consisting of: missing neighbor rule; non-optimal parameter rule; and handoff blocking rule.

17. A system comprising:
a wireless communication system adapted for RF communication with wireless communication devices and adapted for network data communication with a network; and
a wireless communication test system adapted to gather RF information regarding the RF communication and adapted for gathering network information regarding the network data communication and for correlating the RF information and the network information and adapted to identify a problem relating to the wireless communication system based on the correlated information and adapted to recommend solutions for the identified problem.

18. The system of claim 17 wherein the wireless communication test system includes:
a rules-based engine for applying predefined rules to the correlated information to identify the problem.

19. The system of claim 18 further comprising:
rules for identifying the problem as a cause for a plurality of dropped calls in a cellular telephony wireless communication system.

20. The system of claim 19 wherein the rules further comprise a selected rule from the group of rules consisting of: missing neighbor rule; non-optimal parameter rule; and handoff blocking rule.
